(19) United States
(12) Patent Application Publication
(10) Pub. No.: US 2026/0159240 A1
(43) Pub. Date: Jun. 11, 2026

(54) PARTITION DEVICE FOR SEAT

(71) Applicant: TOYOTA BOSHOKU KABUSHIKI KAISHA, Aichi (JP)

(72) Inventors: Hiroyuki SUZUKI, Okazaki-shi (JP); Keisuke TAGAMI, Kani-shi (JP)

(73) Assignee: TOYOTA BOSHOKU KABUSHIKI KAISHA, Aichi (JP)

(21) Appl. No.: 19/404,535

(22) Filed: Dec. 1, 2025

(30) Foreign Application Priority Data
Dec. 6, 2024 (JP) 2024-213738

(51) Int. Cl. B64D 11/06; B60N 2/80

(52) U.S. Cl. CPC B64D 11/0606; B60N 2/80; B60N 2002/899

(57) ABSTRACT

A partition device is provided. The partition device of the present disclosure is to be arranged on an upper part of a seatback, and includes: a shade member that covers at least the upper part of the seatback; and a mounting member arranged on an inside of the shade member and provided with a mounting portion for a functional component.

### CROSS-REFERENCE TO RELATED APPLICATIONS

This application claims the benefit of Japanese Patent Application No. 2024-213738 filed on December 6, 2024 with the Japan Patent Office, the entire disclosure of which is incorporated herein by reference.

### BACKGROUND

The present disclosure relates to a partition device to be arranged on an upper part of a seatback.

For example, a partition device for a seat described in Japanese Unexamined Patent Application Publication No. 2022-079139 has a speaker mounted thereon. The speaker is used to output sound to a person seated in the seat.

### SUMMARY

The partition device for a seat described in Japanese Unexamined Patent Application Publication No. 2022-079139 is a structure in which a partition is formed of a single plate material curved three-dimensionally. Accordingly, a mounting portion for the speaker has a shape recessed toward the inside, thus decreasing the design quality of the rear side (outside) of the partition. The present disclosure discloses one example of “a partition device for a seat on which a functional component, such as a speaker, can be mounted” with this point considered.

It is desirable that a partition device to be arranged on an upper part of a seatback comprise, for example, at least one of the following elements.

Specifically, such elements are: a shade member that covers at least the upper part of the seatback; and a mounting member arranged on an inside of the shade member, the mounting member being provided with a mounting portion for a functional component.

This makes it possible, in the partition device for a seat, to allow the shade member to have a shape not affected (restricted) by the mounting portion for the functional component. This, in turn, makes it possible to obtain the partition device that allows the functional component of various kinds to be mounted thereon without significantly decreasing the design quality.

The partition device for a seat may have a configuration below, for example. Specifically, it is desirable that the shade member and the mounting member be coupled to each other to be integrated. This enables the partition device for a seat to have an improved rigidity as compared with the partition device for a seat formed by a single shade member alone.

It is desirable that a sectional shape of the mounting member be a substantially C-shape or substantially U-shape curved inwards towards an inside of the shade member. This enables the partition device for a seat to have a further improved rigidity.

It is desirable that the shade member be capable of covering, in addition to a back side of the upper part of the seatback, one side and another side, in a seat-width direction, of the upper part of the seatback as well, and that, when the functional component is an electrical functional component, the mounting member include, on a side thereof where the shade member is located, an attachment portion to which a control board of the functional component is to be attached.

This makes it possible to arrange wires accompanying the functional component, and/or the control board, in a location not visible from the outside, that is, in a space between the mounting member and the shade member. Thus, the design quality of the partition device for a seat is improved, and the control board and so on can be inhibited from being touched accidentally by an occupant or another person.

Moreover, it is desirable that a vibration suppression material to suppress vibration of the shade member and the mounting member be arranged in at least part of a space formed between the shade member and the mounting member.

This makes it possible, in the partition device for a seat, to enhance an effect of reducing sound leakage to the outside and to inhibit generation of unpleasant vibration noise and so on, for example, without significantly decreasing the design quality.

### BRIEF DESCRIPTION OF THE DRAWINGS

Example embodiments of the present disclosure will be described hereinafter with reference to the accompanying drawings, in which:

FIG. 1 is a view showing a partition device;

FIG. 2 is a view showing a state in which the partition device is fixed to a seatback;

FIG. 3 is a view showing a configuration of the partition device;

FIG. 4 is a view showing a mounting member;

FIG. 5 is a side view of the mounting member;

FIG. 6 is a view showing the partition device; and

FIG. 7 is a view showing a structure of another partition device.

### DETAILED DESCRIPTION OF EXEMPLARY EMBODIMENTS

Embodiments below show examples of embodiments that fall within the technical scope of the present disclosure. That is, invention-specifying matters and so on recited in the appended claims are not limited by specific configurations, structures, and so on indicated in the embodiments below.

The embodiments below are examples of a partition device for a seat to be mounted in a vehicle such as an automobile (hereinafter referred to as a vehicle seat).

Arrows indicating directions, hatched lines, and so on shown in the drawings are provided for the purpose of easier understanding of mutual relationships between the drawings, shapes of members or portions, and so on. Thus, the partition device is not limited by the directions shown in the drawings.

The directions shown in the drawings are directions in a state where the vehicle seat is mounted in the automobile. The drawings provided with hatched lines do not always represent sectional views. A member or a portion described at least with a reference numeral is at least one in number except in a case of being accompanied by a restrictive wording such as “only one”.

In other words, the member or the portion may be two or more in number in a case of not being accompanied by the restrictive wording such as “only one”. The partition device indicated in the present disclosure comprises at least one of (i) an element such as the member or the portion described at least with a reference numeral or (ii) a structural portion shown in the drawings.

### First Embodiment

### 1. Overview of Partition Device

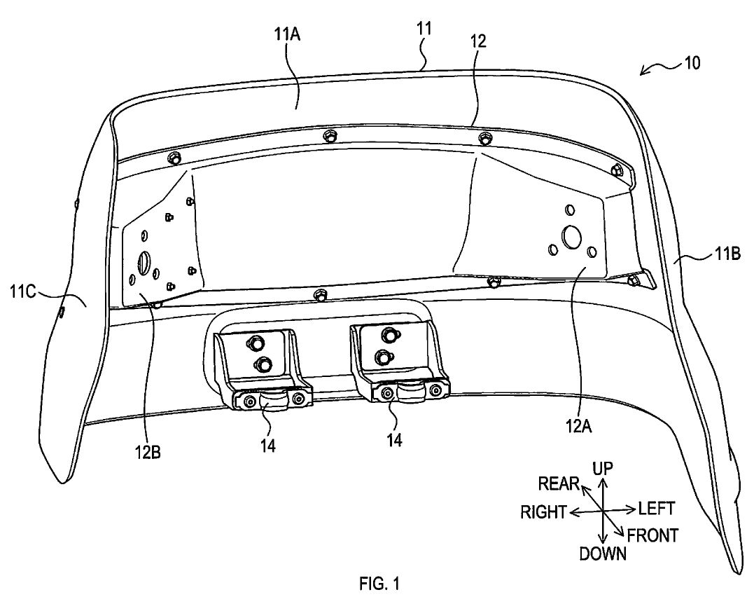

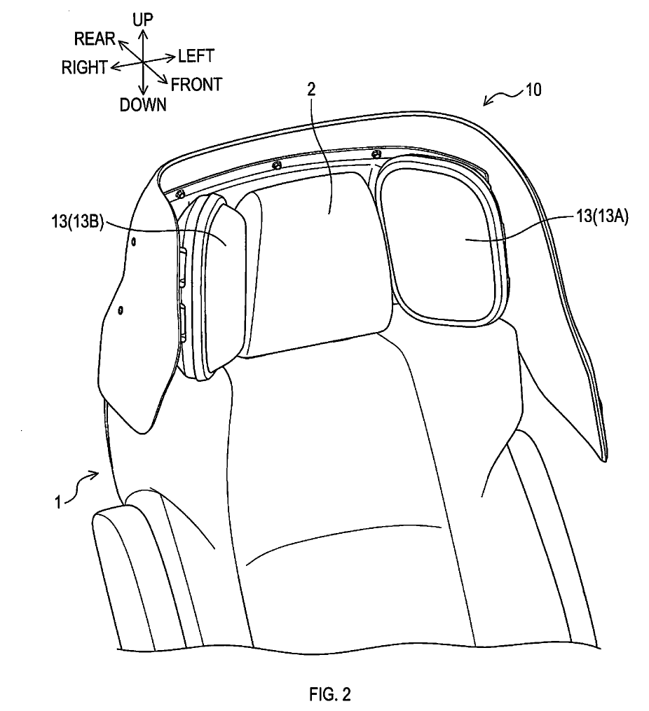

A partition device 10 (see FIG. 1) is fixed to an upper part of a seatback 1 while in use, as shown in FIG. 2. Specifically, the partition device 10 is provided to separate the head of an occupant from the surrounding area in a simple manner by covering the occupant’s head.

The partition device 10 is to be attached and fixed to a headrest stay (not shown). The headrest stay is a member for coupling and fixing a headrest 2 to the seatback 1.

The headrest 2 is provided to an upper end of the seatback 1 to support the back of the head of the occupant. The seatback 1 is one of the members that form the vehicle seat, and supports the back of the occupant.

### 2. Details of Partition Device

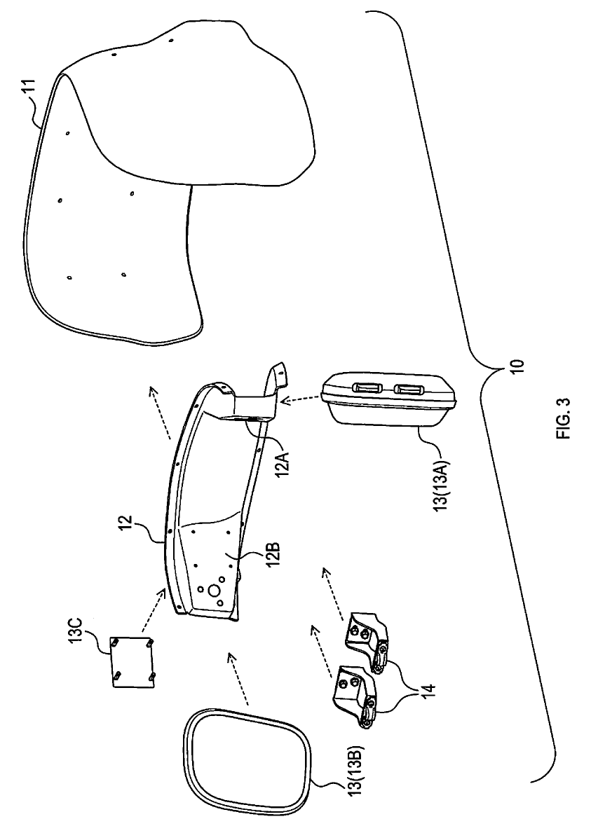

As shown in FIG. 3, the partition device 10 comprises a shade member 11, a mounting member 12, and brackets 14.

### Shade Member

The shade member 11 is a covering member that covers a back side of the upper part of the seatback 1. In addition to the back side of the upper part, as shown in FIG. 2, the shade member 11 can also cover one side and the other side, in a seat-width direction, of the upper part.

Specifically, as shown in FIG. 1, the shade member 11 comprises a first covering portion 11A, a second covering portion 11B, and a third covering portion 11C, and is formed in a substantially C-shape or substantially U-shape opened toward a seat front side. The seat front side refers to, for example, a side where the occupant’s head or the headrest 2 is located with respect to the shade member 11.

The first covering portion 11A covers a rear part of the headrest 2. The second covering portion 11B covers a left side of the headrest 2. The third covering portion 11C covers a right side of the headrest 2. The first covering portion 11A, the second covering portion 11B, and the third covering portion 11C are integrally formed of resin, such as polycarbonate, into a one-piece article.

### Mounting Member

The mounting member 12 is arranged on the inside of the shade member 11 (on the seat front side, in the present embodiment). The inside of the shade member 11 refers to, for example, a side where the occupant’s head or the headrest 2 is located with respect to the shade member 11.

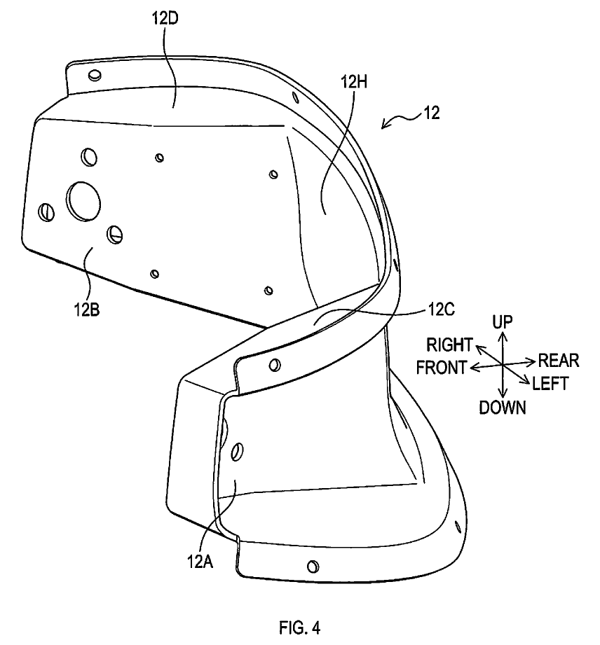

The mounting member 12 is provided with mounting portions 12A and 12B for mounting a functional component 13. As shown in FIG. 4, the mounting member 12 comprises a front portion 12H, a first side portion 12C, and a second side portion 12D, and is formed in a substantially C-shape or substantially U-shape opened toward the seat front side.

The first side portion 12C is provided with the mounting portion 12A, and the second side portion 12D is provided with the mounting portion 12B. The front portion 12A, the first side portion 12C, and the second side portion 12D are integrally formed of resin, such as polycarbonate, into a one-piece article.

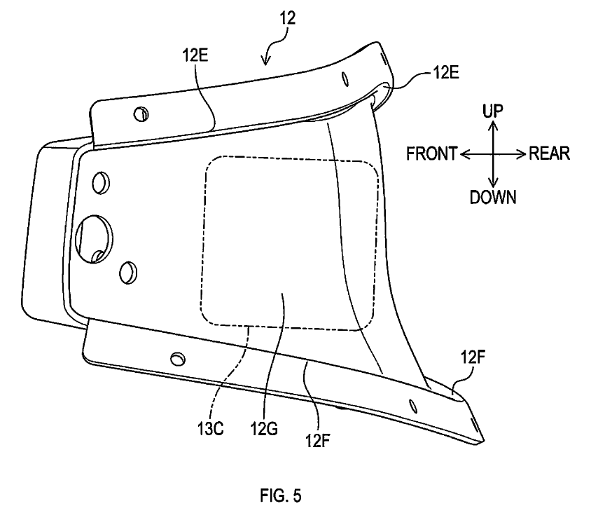

As shown in FIG. 5, a sectional shape of the mounting member 12 is a substantially C-shape or substantially U-shape curved inwards toward the inside of the shade member 11 (toward a seat rear side, in the present embodiment).

The front portion 12A, the first side portion 12C, and the second side portion 12D have, on their upper end side and lower end side, protrusions 12E and 12F, respectively, shaped like ribs. The protrusions 12E and 12F protrude toward the seat rear side, that is, toward the outside of the shade member 11. The outside of the shade member 11 refers to a side opposite to the inside of the shade member 11 across the shade member 11.

The “lower end side” described above refers to a side of the mounting member 12 closer to the upper end of the seatback 1. The “upper end side” described above refers to a side opposite to the “lower end side” across the front portion 12A. The protrusions 12E and 12F are also integrally formed of resin together with the front portion 12A and so on.

The mounting portions 12A and 12B are each configured such that the corresponding functional component 13 is mounted thereon. Examples of the functional component 13 includes a pad such as a cushion member, an air blower (including an air outlet), a microphone, a speaker, and so on.

That is, the functional component 13 is a device for realizing an additional function different from the original function of the seat, “function of seating a person”. Here, the functional component 13 is an electrical functional component, such as a speaker.

Thus, the functional component 13 is hereinafter also referred to as a speaker 13. As shown in FIG. 3, a right speaker 13B is mounted on the mounting portion 12B, and a left speaker 13A is mounted on the mounting portion 12A.

As shown in FIG. 4, the mounting portions 12A and 12B are each formed in a planar shape to allow the corresponding speaker 13 to be mounted thereon. Normal directions of the planes forming the mounting portions 12A and 12B are generally directed toward where the occupant’s ears are to be located.

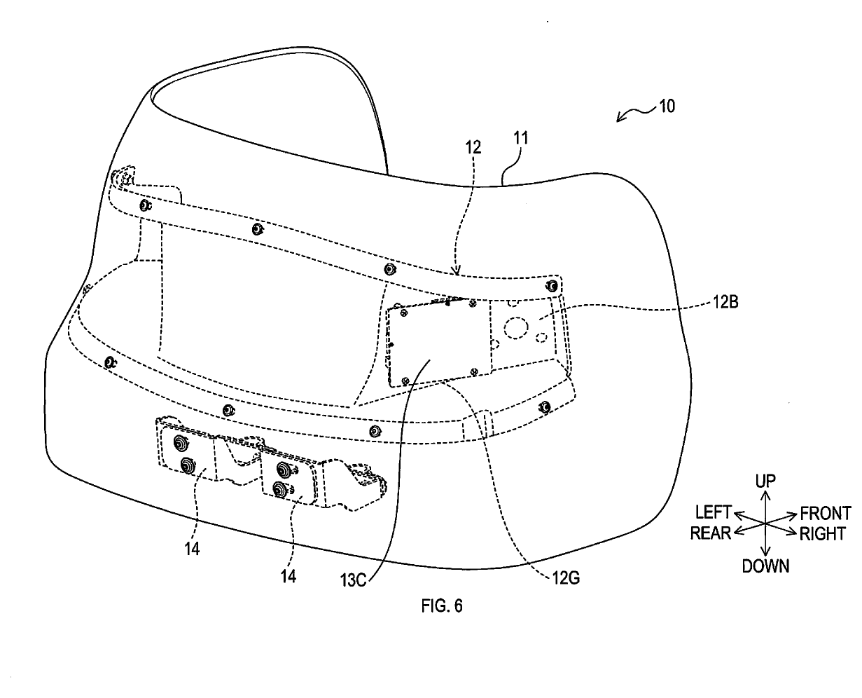

As shown in FIG. 6, the mounting member 12 includes, on a side thereof where the shade member 11 is located, an attachment portion 12G to which a control board 13C is to be attached. Examples of the control board 13C include an electric circuit board including a drive circuit for driving the speaker 13 and other circuits.

### Brackets

The brackets 14 are members for attaching and fixing the partition device 10 to the seatback 1. Specifically, as shown in FIG. 1, the shade member 11 and the mounting member 12 are coupled to each other to be integrated.

The brackets 14 are fixed to the shade member 11. The brackets 14 are to be attached and fixed to the headrest stay. The shade member 11 and the mounting member 12 are coupled to each other with mechanical fasteners, such as pop rivets. Similarly, the brackets 14 are fixed to the shade member 11 with such mechanical fasteners as well.

### 3. Characteristics of Partition Device

The partition device 10 comprises the shade member 11, and the mounting member 12 provided with the mounting portions 12A and 12B for the functional component 13. This makes it possible, in the partition device 10, to allow the shade member 11 to have a shape not affected (restricted) by the mounting portions 12A and 12B for the functional component 13.

This, in turn, makes it possible, in the partition device 10, to mount the speakers 13, which are one example of the functional components, so as to be directed toward where the occupant’s ears are to be located, and also to achieve both a high design quality and a high acoustic performance.

Moreover, it becomes possible for the partition device 10 to be adapted to various specifications at low cost by replacing the mounting member 12. In other words, it becomes possible to obtain the partition device 10 that allows the functional components 13 of various kinds to be mounted thereon without significantly decreasing the design quality.

In the partition device 10, the shade member 11 and the mounting member 12 are coupled to each other to be integrated. This enables the partition device 10 to have an improved rigidity as compared with the partition device 10 formed by a single shade member alone.

The sectional shape of the mounting member 12 is a substantially C-shape or substantially U-shape curved inwards toward the inside of the shade member 11. This enables the partition device 10 to have a further improved rigidity.

In the partition device 10, the shade member 11 covers the back side, and one side and the other side, in the seat-width direction, of the upper part of the seatback 1, and the attachment portion 12G for the control board 13C is provided on the mounting member 12 on the side thereof where the shade member 11 is located.

This makes it possible to arrange wires accompanying the functional component 13, and/or the control board 13C, in a location not visible from the outside, that is, in a space between the mounting member 12 and the shade member 11. Thus, the design quality of the partition device 10 is improved, and the control board 13C can be inhibited from being touched accidentally by the occupant or another person.

### Second Embodiment

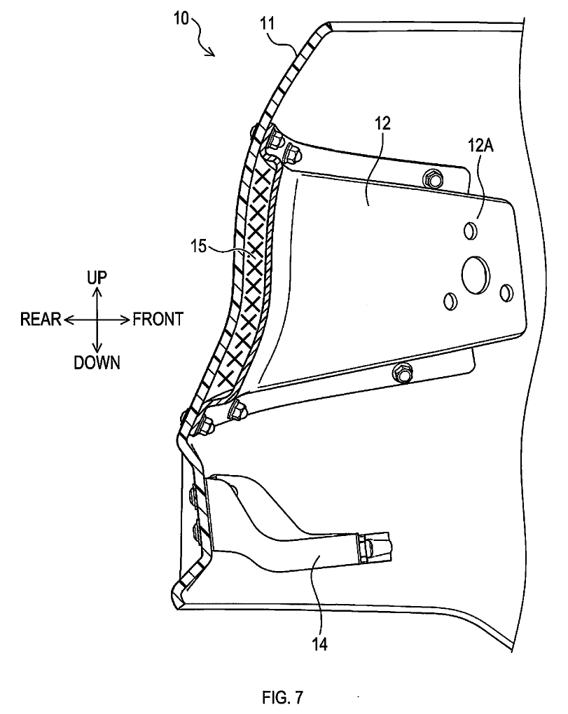

As shown in FIG. 7, the partition device 10 is configured such that a vibration suppression material 15 is arranged in at least part of the space formed between the shade member 11 and the mounting member 12.

The vibration suppression material 15 can be expected to produce an effect of suppressing vibration of the shade member 11 and the mounting member 12. Specifically, examples of the vibration suppression material 15 include a sound absorbing material such as urethane, a vibration damping member such as a weight, and an attenuator such as a damper. In the present embodiment, the above-described space is filled with urethane.

This makes it possible, in the partition device 10, to enhance an effect of reducing sound leakage to the outside and to inhibit generation of unpleasant vibration noise and so on, without significantly decreasing the design quality.

### Other Embodiments

The shade member 11 of the above-described embodiments is a substantially C-shaped or substantially U-shaped member that covers, in addition to the back side of the upper part of the seatback 1, one side and the other side, in the seat-width direction, of the upper part as well. However, the present disclosure is not limited thereto. For example, the shade member 11 may be a flat plate-shaped member that covers only the back side of the upper part.

The above-described embodiments have a configuration in which the shade member 11 and the mounting member 12 are coupled to each other and in which the shade member 11 and the mounting member 12 are fixed to the seatback 1 via the shade member 11. However, the present disclosure is not limited thereto.

For example, a configuration may be employed in which the shade member 11 and the mounting member 12 are each fixed to the seatback 1, or a configuration may be employed in which the shade member 11 and the mounting member 12 are coupled to each other and in which the brackets 14 are provided to the mounting member 12.

In the above-described embodiments, the sectional shape of the mounting member 12 is a substantially C-shape or a substantially U-shape. However, the present disclosure is not limited thereto. For example, the mounting member 12 may have a section of a substantially L-shape, I-shape, or another shape.

In the above-described embodiments, the functional component 13 is an electrical functional component, such as a speaker, and thus, the attachment portion 12G for the control board 13C is provided on the surface of the mounting member 12 on the side thereof where the shade member 11 is located. However, the present disclosure is not limited thereto. For example, a configuration may be employed in which the attachment portion 12G is not provided.

In the above-described embodiments, after the shade member 11 and the mounting member 12 are manufactured separately, then the shade member 11 and the mounting member 12 are integrated with the mechanical fasteners. However, the present disclosure is not limited thereto.

The mounting portions 12A and 12B of the above-described embodiments are each formed in a planar shape. However, the present disclosure is not limited thereto. For example, the mounting portions 12A and 12B may each be formed to have a recess and/or a protrusion.

The partition device 10 of the above-described embodiments is designed to partially surround the headrest 2. However, the present disclosure is not limited thereto. For example, a partition device to cover an upper end side of the seatback may be employed because it is also applicable to a seatback with no headrest.

In the above-described embodiments, the vehicle seat according to the present disclosure is applied to an automobile. However, application of the disclosure disclosed herein is not limited thereto. For example, the present disclosure is also appliable to a seat used in vehicles, such as railroad vehicles, ships, or aircraft, as well as to a stationary seat used in theaters, at home, or in other places.

Moreover, it is sufficient that the present disclosure be consistent with the gist of the disclosure described in the above-described embodiments, and the present disclosure is not limited by the above-described embodiments. Therefore, a configuration may be employed in which at least two embodiments among the above-described embodiments are combined together or in which any of the elements shown in the drawings or the elements described with reference numerals is omitted in the above-described embodiments.

What is claimed is:

1. A partition device for a seat to be arranged on an upper part of a seatback, the partition device comprising:
a shade member that covers at least the upper part of the seatback; and
a mounting member arranged on an inside of the shade member, the mounting member being provided with a mounting portion for a functional component.

2. The partition device for a seat according to claim 1,
wherein the shade member and the mounting member are coupled to each other to be integrated.

3. The partition device for a seat according to claim 2,
wherein a sectional shape of the mounting member is a substantially C-shape or substantially U-shape curved toward an inside of the shade member.

4. The partition device for a seat according to claim 3,
wherein the shade member is capable of covering, in addition to a back side of the upper part of the seatback, one side and another side, in a seat-width direction, of the upper part of the seatback as well, and
wherein, when the functional component is an electrical functional component, the mounting member includes, on a side thereof where the shade member is located, an attachment portion to which a control board of the functional component is to be attached.

5. The partition device for a seat according to claim 3,
wherein a vibration suppression material to suppress vibration of the shade member and the mounting member is arranged in at least part of a space formed between the shade member and the mounting member.
